(19) United States
(12) Patent Application Publication
(10) Pub. No.: US 2026/0127586 A1
(43) Pub. Date: May 7, 2026

(54) SYSTEMS AND METHODS FOR TRAVERSING DISTRIBUTED LEDGER DATA STRUCTURE FOR GENERATING DECENTRALIZED CREDIT SCORE DATA OBJECTS

(71) Applicant: HSBC Software Development (Guangdong) Limited, Guangdong (CN)

(72) Inventors: Wei Ming Zhuang, Shanghai (CN); Renyuan Tan, Shanghai (CN); Junbao Duan, Shanghai (CN); Fei Pang, Shanghai (CN)

(21) Appl. No.: 19/426,923

(22) Filed: Dec. 19, 2025

(30) Foreign Application Priority Data
Dec. 31, 2024 (CN) 202411999844.1

(51) Int. Cl. G06Q 20/38

(52) U.S. Cl. CPC G06Q 20/38215; G06Q 20/3825

(57) ABSTRACT

A blockchain / distributed ledger based approach for traversing distributed ledger data structures for generating cryptographically verifiable presentation data objects is proposed herein. The approach can be utilized as a mechanism for using a combination of cryptographically generated verifiable credential data objects with cryptographically generated verifiable presentation data objects, verifying characteristics of a user or a computational process, such as whether a user is a graduate of a particular educational institution, whether the user has a transaction history that warrants a score greater than a threshold, or whether the user has sufficient access credentials to access a controlled resource. Zero knowledge proofs are proposed as a mechanism for generating verifiable proofs to protect sensitive verifiable credential data objects. The score can be generated using a black box machine learning model.

### CROSS-REFERENCE TO RELATED APPLICATIONS

This application claims priority to and the benefit of Chinese Application No. 202411999844.1, filed December 31, 2024, the contents of which are incorporated into the present application by reference.

### FIELD

Embodiments of the present disclosure relate to the field of cryptographic data object generation, and more specifically, embodiments relate to systems and methods for traversing distributed ledger data structures for generating cryptographically verifiable presentation data objects.

### INTRODUCTION

A challenge with the credit rating process of traditional credit institutions arises in relation to the difficulty of consolidating and modelling user data in non-uniform data formats from various platforms as the different data formats require complex cleaning of the user data, which consumes manpower and material resources. Furthermore, because the user data is stored on various platforms (e.g., data relating to vehicle ownership, real estate rights, intellectual property, etc.), it is difficult for users to directly use all the data as each platform may have permission restrictions that prevent users from using the data in other applications, resulting in users losing control over the user data that should belong to them.

For example, data from various asset platforms, such as the user’s vehicle ownership information and real estate rights, will be in different data formats than the user’s social identity data (e.g., educational background, work background, etc.) and would be difficult to consolidate for modelling the user’s credit status.

Some third-party payment platforms have built their own credit systems, the main data sources of which come from transaction data generated by the platforms themselves, as well as some additional asset liability data and interpersonal relationships data related to users within the platform’s service ecosystem that are used for modelling and assessing users’ credit status. However, these systems have a limited application range and it is difficult to be widely applied to broader situations.

A potential reason for the deficiencies of these traditional approaches is limitations in the data sources used to obtain user data which cannot fully reflect and represent the credit status of users.

### SUMMARY

A blockchain / distributed ledger based approach for traversing distributed ledger data structures for generating cryptographically verifiable presentation data objects is proposed herein. The approach can be utilized in practical implementations as a mechanism for using a combination of cryptographically generated verifiable credential data objects with cryptographically generated verifiable presentation data objects, which are used to verify characteristics of a user or a computational process, such as whether a user is a graduate of a particular educational institution, whether the user has a transaction history that warrants a score greater than a threshold, or whether the user has sufficient access credentials to access a controlled resource.

Verifiable presentation data objects can be generated or transmitted automatically in response to or triggered by verification request data request messages, such as by an incoming message from a verifier device requesting verification. A verifier device, for example, could be a payment terminal that provides student discounts, or the payment terminal could be configured to modify a user interface flow based different credit options that may be made available, for example, if the user’s credit score is greater than a particular threshold.

Alternatively, the system, instead of serving a user, may also be utilized to generate verifiable presentation data objects that are used for determining whether a process has sufficient computing process permissions to be able to access a virtual controlled resource. In this example, a computing process may have a verifiable credential data object that provides access level 5 generated by a certificate authority, and a verifiable presentation data object is generated when the process is interrogated for permissions before access.

The approach described herein provides a computational mechanism that serves as a unified identity management system that is represented using cryptographic data objects, and the verifiable proofs that are generated can be used for carrying out transactions, obtaining access to specific features only available to individuals with elevated credentials or permissions. As an applied, non-limiting use case, the data architecture provided herein, for example, can be used to evaluate the credit of the user’s unified identity, and a verifiable credit certificate can be issued to the user. This credit certificate can also be used in other systems, providing users with differentiated services based on credit levels.

### DESCRIPTION OF THE FIGURES

In the figures, embodiments are illustrated by way of example. It is to be expressly understood that the description and figures are only for the purpose of illustration and as an aid to understanding.

Embodiments will now be described, by way of example only, with reference to the attached figures, wherein in the figures:

FIG. 1 is an example data flow diagram showing steps of a data interaction for generating cryptographically verifiable presentation data objects for presentation, according to some embodiments.

FIG. 2 is a block schematic diagram showing an example service architecture structure, according to some embodiments.

FIG. 3A, FIG. 3B, FIG. 3C is an example data message flow diagram 300 (extended across the three figures) that shows example service calls that are made between the three main bodies (user, issuer, CBDC platform), which can be used as a reference for the development of specific product function modules.

FIG. 4 shows an example set of data sources for a scoring model, according to some embodiments.

FIG. 5 is an example score rating model, according to some embodiments.

FIG. 6 shows a practical example where a user is attempting to rent a bicycle at a bicycle rental terminal, according to some embodiments.

### DETAILED DESCRIPTION

Embodiments of methods, systems, and apparatus are described through reference to the drawings.

Disclosed herein includes a system configured to generate a unique verifiable credit rating certificate for a user. For example, the system may be configured to model credit ratings for a user based on the user’s behaviour on a digital currency platform.

With the emergence of “Web3” technology that extends cryptocurrency to forming a new iteration of internet based on decentralized networks, blockchain technologies and token-based economics, more distributed and user-driven network environments have been created, improving the transparency and efficiency of financial transactions. Central banks around the world are actively adopting Web3 technology as the basis for the design and development of the next generation of currency, giving rise to, for example, the digital currency Central Bank Digital Currency (CBDC). Decentralized identity management technology has also been used to empower users to autonomously hold and manage their own data, eliminating the need for users to store personal data in traditional centralized service databases. Utilizing this technology, users can access corresponding services in different systems through a unified identity. Using both Web3 technology and decentralized identity management technology, users can use a unified identity to conduct transactions in CBDC, generating financial-related data that can be used for credit evaluation of the user’s unified identity to generate and issue verifiable credit rating certificates to users. Such credit rating certificates would be universal in other systems and can provide users with differentiated services based on users’ credit ratings.

Traditional approaches such as credit institutions' credit rating is deficient because it requires the consolidation and modeling of user data from various banks, including transaction data, assets and liabilities data, as well as data from asset platforms such as vehicle ownership, real estate rights, intellectual property rights, and social identities, such as educational background and work background. The data is distributed across different platforms, making it challenging to consolidate and, given the lack of uniformity in data formats, necessitates complex data cleaning work, consuming significant human and material resources. At the same time, all these data are stored on other platforms, making it difficult for users to utilize them or requiring permission from other service institutions to use this data for other services. This results in users losing control over their own data, which inherently belongs to them.

In contrast, embodiments described herein allow users to manage their own cryptographic credit rating certificates and autonomously obtain related financial services at other service institutions using the cryptographic credit rating certificates generated based on the users’ behaviour data on their own devices. The technical approach described herein provides users with a more efficient, fair, and personalized credit rating and management system, improving the transparency of credit rating determination and securing users’ rights and interests over their user data. Users can then use these generated data objects to directly manage and utilize their credit information while providing financial service institutions with more accurate and live user credit data, improving efficiency and quality of financial services.

As described herein, a unified platform is proposed that utilizes uniform data objects that allows multiple financial service institutions to operate with docking and data sharing between systems, improving collaborative efficiency of different financial service institutions and allowing for more direct and convenient credit rating computation and management of users. The approach provides a distributed ledger / blockchain architecture that provides a platform that can aggregate user information from multiple financial institutions and generate data in a unified format to address the issue of "data islands" where user information in different financial institutions is isolated from each other. This enables the generation of a more comprehensive and objective identity rating. In some embodiments, the platform can be a blockchain / distributed ledger architecture that is configured to support one or more central bank digital currencies, for example, as decentralized data objects.

Where central bank digital currency data objects are utilized, transaction flows and patterns can be tracked and monitored, in combination with holdings that can be accessed using a blockexplorer tool to generate a robust snapshot of the financial characteristics of a particular digital wallet (and by proxy the user who owns the digital wallet). As described herein, other signed digital objects can also be maintained either locally or on a distributed ledger, these signed digital objects including, for example, verifiable credentials generated by a university indicating proof of graduation or enrollment, along with other fields, such as whether the user graduated with honors, the user’s score at graduation or for individual courses, the name of the courses, the date of enrollment, and so forth.

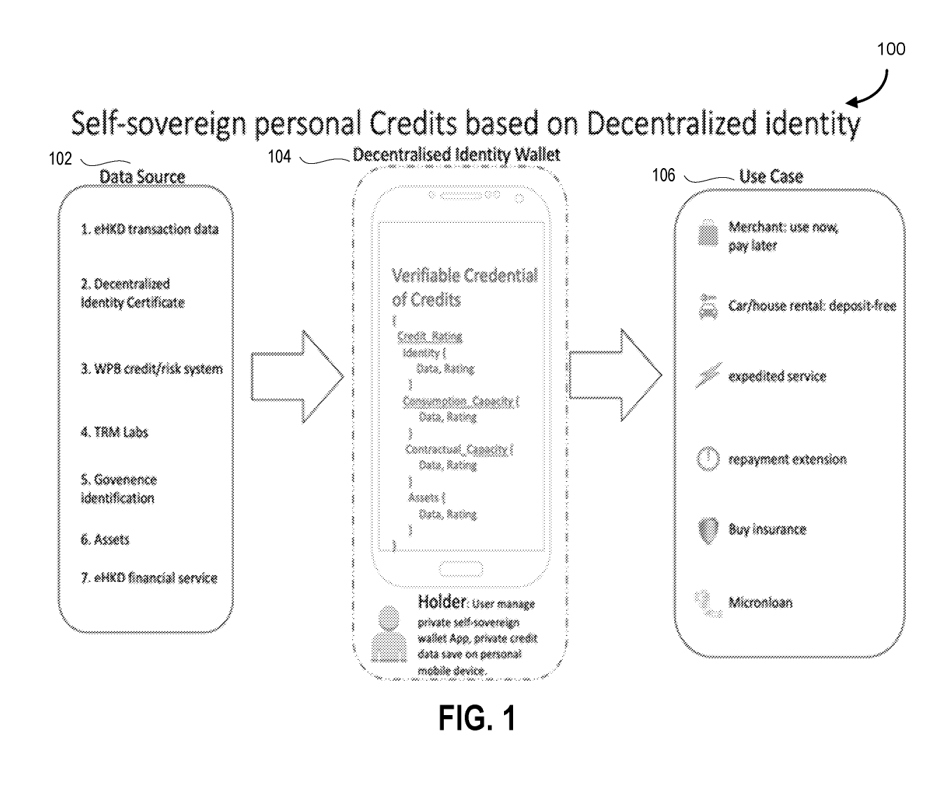

FIG. 1 is an example data flow diagram showing steps of a data interaction for generating cryptographically verifiable presentation data objects for presentation, according to some embodiments. In the diagram 100 in FIG. 1, the approach can be divided into three steps.

At 102, the data process begins with collection and cleaning of credit-related data for users, converting various difficult-to-standardize personal credit data into a unified data format for the platform for subsequent use. This process requires the platform to provide a unified paradigm definition platform interface and confirm the conversion relationship from business data to platform data one by one.

At 104, the processed data source and received data is used for credit rating calculation, and a verifiable credential data object is generated representing the calculation rating result, and stored on the user's mobile device.

At 106, in operation, and potentially at a later time, in specific application scenarios, a user is able to use the user’s mobile device to show the rating results as needed, prove their credit level. The presentation can be conducted using a verifiable presentation data object that is generated based on a combination of one or more verifiable credentials data objects. The verifiable presentation data object is generated as a zero knowledge proof attestation based on the one or more verifiable credentials data objects, and the user is not required to transmit the underlying one or more verifiable credentials data objects to the device conducting the verification.

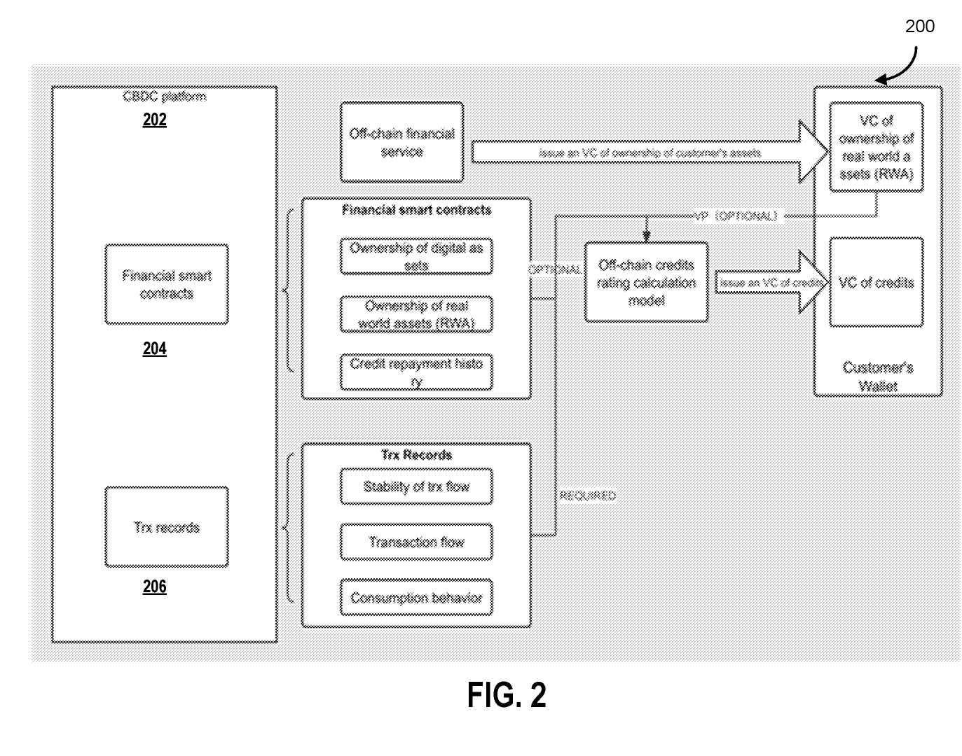

FIG. 2 is a block schematic diagram showing an example service architecture structure, according to some embodiments. In 200, a CBDC platform 202 is provided that can include one or more smart contracts 204, and accessible transaction records 206. A blockexplorer data service can be used to query the distributed ledgers to obtain information from the CBDC platform 202, such as the ownership of various digital assets, non-fungible tokens representing real world assets, and process transaction records, such as repayment history, transaction flows, and/or consumption behavior through transaction patterns.

As shown in FIG. 2, the user's smart contract and transaction history are stored on the CBDC platform and can serve as input for the offline score determination model. Model input also includes VCs generated by financial product services inside and outside the CBDC platform. The two can be combined for calculation, and the rating result is also issued as a VC and stored on the user's mobile device.

The off-chain asset trusted credential issuance platform 208 can be another data source that can be configured to generate verifiable credential data objects pertaining to the user’s ownership of assets as tracked within their records. These can include financial securities ownership certificates, among others, account holdings, land registries that store records of physical ownership, off chain.

A unified format can be provided for verifiable credential data objects, which are each data objects that can be signed by a cryptographic certificate authority associated with each of the verifiable credential issuers. In some embodiments, the public keys of the certificate authority are made available for validation. The verifiable credential data objects are persisted on a verifiable credential data object wallet application that can reside on a user’s device, and can be confidential / secure data objects that can be transmitted from device to device. The verifiable credential data objects are sensitive informational elements and in some embodiments, are stored on trusted execution environments or enclave memory sections of the user’s device, such as a high security data storage that is segregated from other data storage, for example.

Similarly, include one or more smart contracts 204, and accessible transaction records 206 are configured to generate an external data output based on an exploration of the on-chain transaction records, defining the external data input into a unified format (such as VC) for CBDC and provide interfaces for integration with external business entities. Its purpose is to transform the external business data traversed in the form of transaction records into a unified format for programmable determinations.

In some embodiments, a credit rating determination engine 210 is configured to generate one or more consolidated score values based on the user’s available the on-chain transaction records, by traversing all transactions relating to the wallet’s public address.

The credit rating determination engine 210 can be implemented in different ways. For example, the credit rating determination engine 210 can be implemented as a data engine that is configured to generate a user’s credit score based on the user’s transaction history, and the data engine can operate off-line.

In another variation, the credit rating determination engine 210 instead is a smart contract that operates on-chain as a state machine and is configured to expose an application programming interface where a data message can be provided to the credit rating determination engine 210 containing a public wallet address, the credit rating determination engine 210 automatically begins traversing transaction records associated with the public wallet address, and generates a verifiable credential data object that is usable for a period of time after generation. In this example, the credit rating determination engine 210 includes a generated public / private key pair and exposes the public key, and signs the verifiable credential data object using the corresponding private key such that the verifiable credential data object and/or the corresponding generated verifiable proof can be verified against the credit rating determination engine 210’s smart contract public key.

In a further variation of the smart contract version of the credit rating determination engine 210, the credit rating approach can be encapsulated and implemented as a publicly accessible code circuit that is readily verifiable by third parties. The credit rating determination engine 210 in this example can include executable code stored thereon which, when executed, executes a specific type of pattern or asset test, such as an acid-test ratio, a loan to value ratio, or a combination thereof. Accordingly, in this example, the credit rating determination engine 210’s rating methodology is made available for additional verification, as required by a verifier accessing and interrogating the publicly accessible code circuit that is being executed.

In an alternate variation of the smart contract version of the credit rating determination engine 210, the credit rating approach is instead intentionally a “black box” model where third parties are not able to access the underlying executable code. This can be useful in situations where the credit rating algorithm itself is a proprietary blend of weights and logical gates, or where it is important to keep the credit rating algorithm secret to avoid third parties being able to maliciously affect the credit scores through intentional transaction activity designed to cause a mis-classification.

In a further variation of the alternate variation, the black box” model is a machine learning black box model where the underlying weights and parameters for the scoring approach are continuously or periodically updated iteratively to optimize for a particular outcome or parameter. For example, in this further variation of the alternate variation, a benefit of using a machine learning model is that it becomes harder for the malicious third party to cause a misclassification as the model is adapting in real-time or near-real time based on patterns of fraud. In this example of the further variation of the alternate variation, the smart contract is configured to periodically retrieve datasets of identified non-payment or fraud, and compare against different parameters relating to the stored digital assets and transaction flows to continuously update a probability distribution representation that is implemented through adjustable weights and parameters of a neural network model.

The issued verifiable credential data objects can be stored on the user's mobile device, and optionally can also be stored in a cloud storage backup.

The computational processes for generating the verifiable credential data objects can include issuance authorities that generate signed or encrypted data objects based on public / private key architectures, for example, using a certificate authority server that has an exposed public key that is used to sign verifiable credential data objects.

In some embodiments, the verifiable credential data objects can be stored as plaintext data objects with digital signatures, while in other embodiments, the verifiable credential data objects are encrypted data objects that are both signed and encrypted using the corresponding private key such that the data objects, even if stolen, cannot be easily decrypted to obtain the underlying information. In a further example, the verifiable credential data objects include a proxy payload instead that includes a credentialed pointer object that refers to a secured resources stored on a secure server, where a user, if needing to access the data record, still needs to use the pointer to access the secured resource on the secure server using the credentials and the pointer. All of these variations provide different levels of security in respect to the verifiable credential data object, especially if there is risk of a replay attack or a data breach in respect of the secure data storage of the verifiable credential data object.

The verifiable credential data objects can be generated using repeatable processes that can be invoked, for example, based on records stored at a third party institution, such as a university, an employer, a government agency, among others.

For the financial smart contracts, in a further variant embodiment, the verifiable credential data object generation process itself can be publicly exposed as a smart contract functionality that is accessible through the distributed ledger smart contract execution framework, such as having a specialized verifiable credential data object generation smart contract that any party can invoke by providing the user wallet public key, and the payment of associated computational execution (e.g., “gas” fees) that are required for the generation protocol. A benefit of using this variation is that if the verifiable credential data object generation process can be publicly audited in the publicly accessible execution code of the smart contract, there can be greater trust in the methodology used in the generation of the verifiable credential data objects.

In this example, the smart contract functionality then provides a “self serve” mechanism where a user can, at the user’s or the user’s device’s convenience, request the generation of verifiable credential data objects corresponding to the user’s transaction record at any time to yield a storable token that can be stored on the user’s device and used, for example for offline transactions and verification processes described herein, for example. This is especially useful if the computational verification and generation of a credit score, for example, based on the user’s transaction history requires a period of time and is computationally intensive.

A user’s device may periodically invoke the function, receive the verifiable credential data object token after a period of time (e.g., 2-3 days where the transactions are queued up for execution during low load times of the blockchain network). The verifiable credential data objects can thus then be stored locally for generating presentation proofs as described herein as responsive data messages.

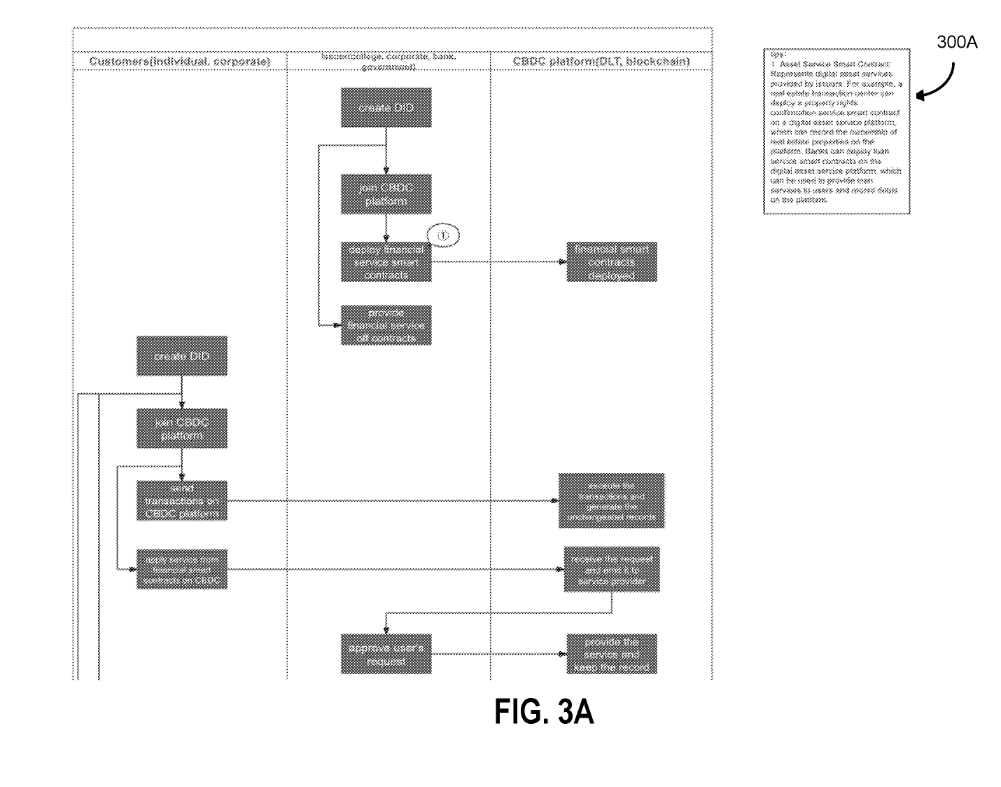

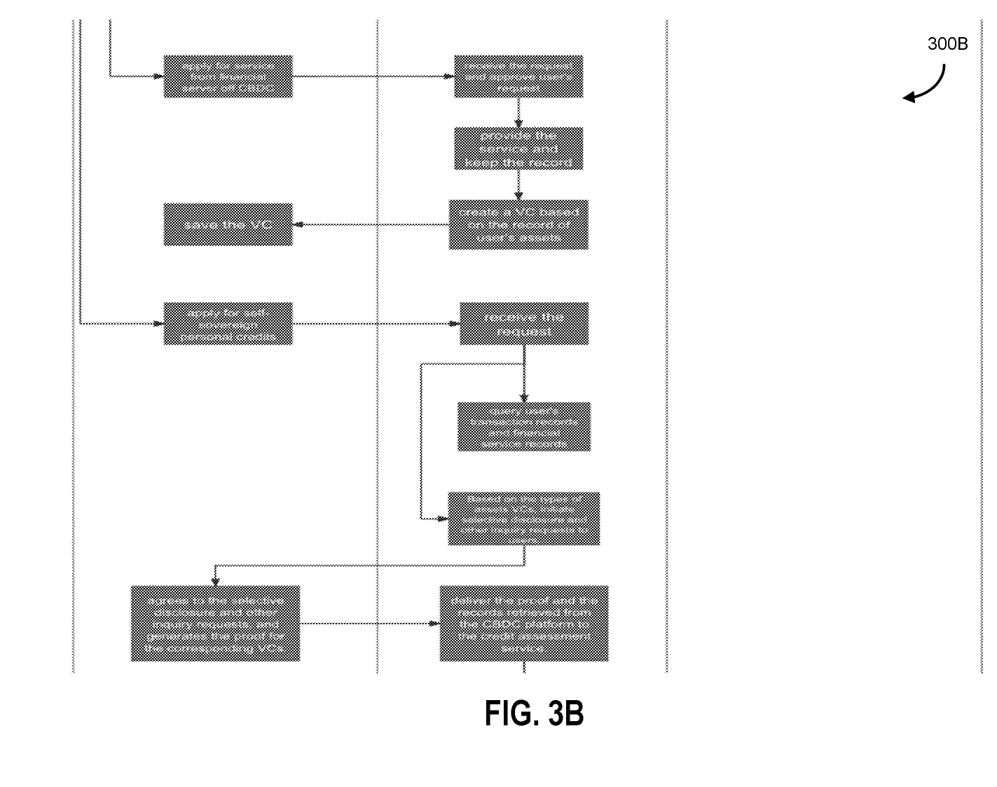

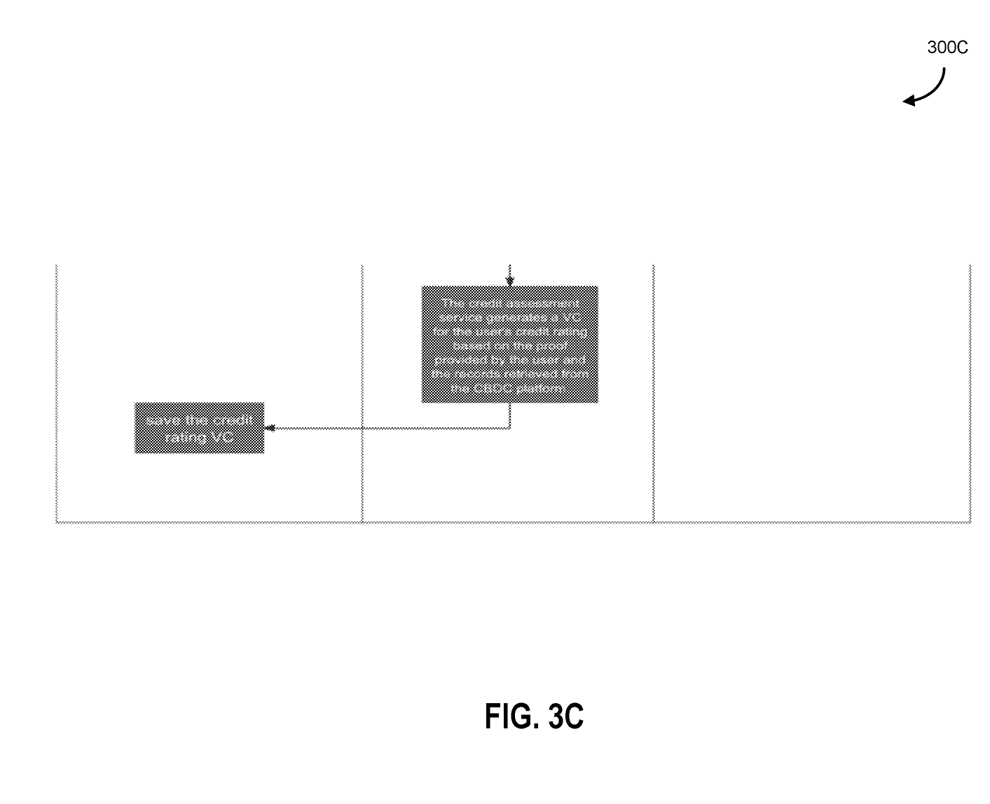

FIG. 3A, FIG. 3B, FIG. 3C is an example data message flow diagram 300 (extended across the three figures) that shows example service calls that are made between the three main bodies (user, issuer, CBDC platform), which can be used as a reference for the development of specific product function modules.

As shown in 300A, 300B, and 300C, the data message flows are designed for generating a verifiable credential as described above. At the end of one or more asynchronous generation process flows, the user’s wallet now has a plurality of different verifiable credentials. These can include an indication that Adam Smith owns real estate property #1001050, Adam Smith has 150000 RMB in an account, Adam Smith graduated from Tsinghua University in 2006 with a 3.61 GPA and a honors standing, Adam Smith has ownership of vehicle registration 3P20MACANZA, Adam Smith owns public wallet abcde111100, and Adam Smith is born on January 1, 1990, in Hong Kong, China.

Each of these primary verifiable credential data objects were generated by different generation sources, and the verifiable credential data objects can include the actual field values, which have sensitive information, such as his date of birth, his social security number, his student number, among others. There can also be derivative credential data objects generated using other primary information, such as a credit score generated by Credit Score Company A's off chain validation service, or Credit Score Company B’s smart contract for validation. As described herein, or Credit Score Company B may use a black box model for implementing its proprietary scoring algorithm, which is then stamped with approval using or Credit Score Company B’s certificate authority system. In this example, or Credit Score Company B’s black box model may be different variations of an adaptive model that is continually traversing records of non-payment and updating model parameters.

The verifiable credential data objects should only be stored on the user’s device with user authorization, and during presentation time, for example, when a verifier device, such as a verifier’s terminal device is requesting a verification, the user’s device is configured to amalgamate or otherwise combine or transform the verifiable credential data objects using zero-knowledge proof objects to meet a verification challenge and generate a zero-knowledge proof attestation that is transmitted back to the verifier’s terminal device. A benefit of using the zero-knowledge proof objects is that the underlying verifiable credentials do not need to be transmitted across insecure transmission protocols or across publicly accessible and potentially untrustworthy networks, significantly limiting the ability for replay attacks to be conducted using the verifiable credential data objects.

On the other hand, the zero-knowledge proof objects that represent the verifiable presentation data objects can be one-time use generated and the zero-knowledge proof protocols can be generating the verifiable presentation data objects to meet very specific requests from the verifier device. For example, the verifier device may be satisfied so long as the credit score is greater than 500, and in the approach proposed herein, the actual credit score does not need to be provided, the generated verifiable proof simply indicating that the credit score is greater than 500. This allows for improved prevention of information leakage, as the verifiable presentation data object cannot be replayed and further, cannot be reverse engineered to obtain the verifiable credential or the underlying value.

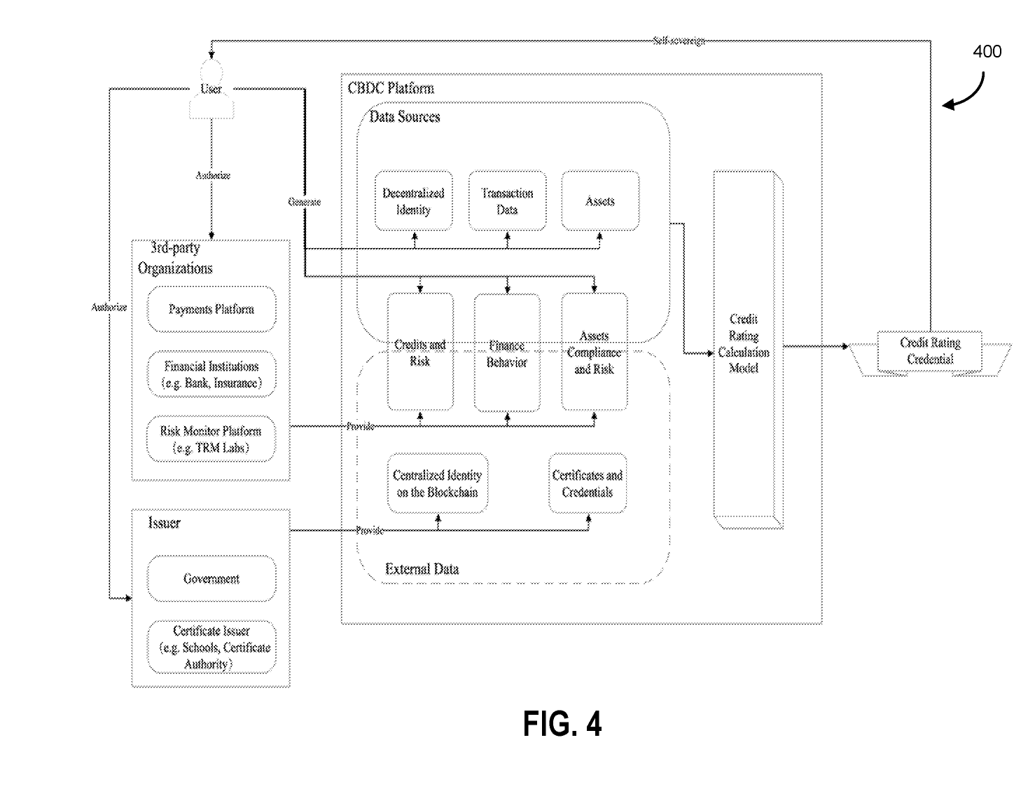

FIG. 4 shows an example set of data sources for a scoring model, according to some embodiments.

As proposed in 400, in addition to verifiable credentials generated by different organizations, a derivative verifiable credential data object can be generated as a transformed or generated proxy based, for example, on a snapshot of the user’s historical transaction record for the purposes of generating a specific score. The derivative verifiable credential data object acts as a proxy for a credit score, for example, and can be computationally expensive to generate. However, once it is generated, it can be used for a period of time before a new data object needs to be generated.

In some embodiments, the user’s device or mobile application is configured to automatically invoke the process based on a refresh cycle that is built into the token, such that a newly validated or newly generated token is generated on a periodic cycle based on the user’s transaction information.

Diagram 400 shows an example set of data sources that can be used to provide source data for the user self-managed identity credit model. In some embodiments, these can be based on CBDC transfer flows, such as all data related to the user (e.g., the user’s wallet) within the CBDC platform, including but not limited to, data directly generated on the CBDC platform and data inputted from external sources. When invoked, the credit model data structure automatically traverses the on-chain transaction record for obtaining user transaction data on the CBDC platform, which refers to transaction data generated by the user within the CBDC platform.

The CBDC platform can be used to obtain user decentralized identity credentials on the CBDC platform, which refers to decentralized self-managed identity credentials generated by the user on the CBDC platform for self-management (e.g., saving / storing locally on the user’s device).

When the user invokes the process flow, for example, through an API call data message, the process begins obtaining user credit and risk data from the CBDC platform or third-party credit and risk systems associated with the CBDC platform, User credit and risk data refers to the user's credit history and risk representation in financial activities, including but not limited to the following information obtained from the CBDC platform or third-party platforms associated with the CBDC platform. This information can include activity information such as loan information, credit card information, employment and income information, asset and liability situations, and legal records (e.g., has the user been defaulting on loans and not repaying them, which may lead to legal action stored as records on chain).

The process flow is configured to obtain information on the compliance assessment of user assets on the CBDC platform and risk information from transactions generated on the platform. These two pieces of information can be generated by asset assessment models and risk evaluation models within the CBDC platform or recognized third-party models integrated into the CBDC platform. Centralized identity information of the user on the CBDC platform can be obtained by extracting identity information credentials issued by CBDC platform-recognized issuing authorities and recorded on the platform, including but not limited to the following information: Identity card, driver license, business license, degree or diplomatic status, among others.

The process can also further include obtaining user asset information on the CBDC platform, which refers to any form of assets owned by the user within the CBDC platform that can generate economic benefits. The financial service information data can be retrieved in relation to the user on the CBDC platform. The financial services refer to the services provided by the CBDC platform or other financial service institutions utilizing the CBDC platform, for users to use and manage their own assets. These services include but are not limited to: deposit services, loan services, investment services, and insurance services

The technology of the present invention utilizes valuable and available data provided on the CBDC platform to model and analyze user financial behavior, thereby determining the user's identity rating. Furthermore, users can independently manage their identity rating certificates and autonomously obtain corresponding financial services from other service providers using these certificates.

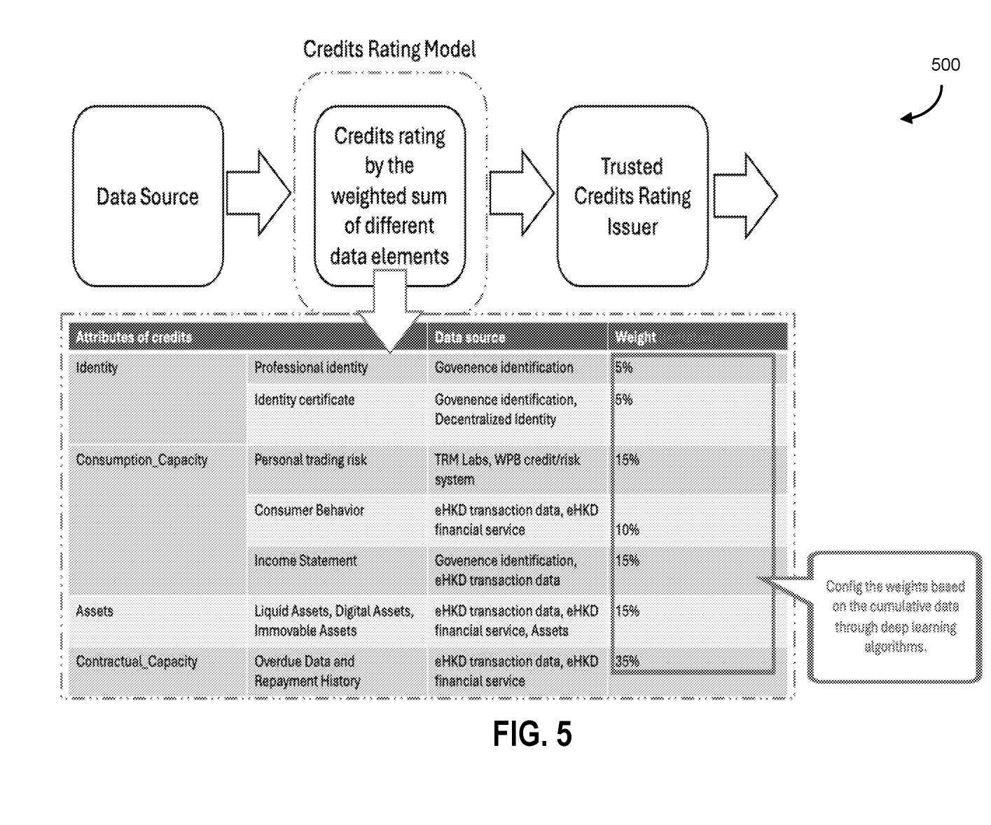

FIG. 5 is an example score rating model, according to some embodiments. The credit rating model 500 as shown can be implemented through a calculation circuit or computer module that executes computer instruction sets based on inputs from a user. As described herein, the score rating model can be used to generate derivative verifiable credential data objects that are derived from various combinations of other characteristics, which themselves may (but are not necessarily) stored and accessible through verifiable credential data objects that have been generated. In the example shown in 500, the attributes of the credits can include identity aspects, consumption capacity aspects, assets, and contractual capacity, which can be used to generate a weighted score.

The input data format for credit rating models can be standardized and cleaned into a blockchain-readable format for subsequent use and calculations. This includes: W3C standard Verifiable Credentials (VC): VCs from different dimensions or business entities should be pre-set on the CBDC platform in a format that complies with VC standards and includes relevant business fields. Blockchain transaction records can be obtained through a blockexplorer data process, and can also include other data formats recognizable by the blockchain, such as NFTs.

The credit rating model uses the model source data to calculate the weight of different dimensions of credit data and derive a final credit score. A non-limiting example for assigning weights to different input data dimensions can include: proof of identity document based on diverse and credible identity documents such as ID cards, driver's licenses, and government-issued certificates contributes to a significant improvement in credit rating.

Consumer behavior and capacity can be measured using proxies such as: transaction risk monitoring where the process includes conducting secure scans on blockchain transactions to prevent financial crimes. For example, using blockchain technologies like anti-financial crime scanning and transaction monitoring, or machine learning, to trace the source and destination of CBDC transaction funds. Funds that may flow into financial crime accounts can significantly impact credit ratings.

Other sources of consumer behavior and capacity data can include transaction history, where ongoing transaction activities are considered indicators of higher stability; employment and income verification where employment and income verification can significantly enhance credit ratings; assets and liabilities where providing diverse asset proofs and lower liabilities can greatly improve credit ratings; a CBDC account balance; ownership of digital assets, such as NFTs corresponding to digital twins of real estate rights on the blockchain; equivalent estimates of financial products; liability records, including loans and the usage of credit contracts on the CBDC platform.

Performance records (transaction records between the user and the bank's lending service contracts) such as those stored in credit products associated with CBDC accounts can also be obtained where good contract performance rates and lower debt ratios help determine that users have a good credit level, assuming CBDC institutions introduce credit financial products related to CBDC; and existing off-chain credit records, such as repayment records for traditional loans and credit cards, that can have a negative impact on credit ratings if loan or credit card payments are not made on time.

The credit rating based on CBDC implementation is obtained by pulling the required source data and performing calculations through centralized services of CBDC institutions, with user authorization. The resulting credit rating is then issued as a credit rating credential by the CBDC institution. The weights assigned to each dimension are not specified in detail here as they should be defined by the specific product design organization during the implementation of specific products or dynamically adjusted during model iteration. Each of the weights can be configured as an adjustable parameter, and the system can be configured utilize one or more deep learning approaches in adjusting based on received feedback datasets relating to either positive payment or negative non-payment interaction data corpuses. By allowing the weights to float and iteratively adjust, the system automatically adjusts for new patterns in payment or non-payment behavior automatically, which is an improvement over static models. Because real-world payment / non-payment data is used, the weighted approach tracks closer to the ground truth. Different model types and parameters can be used, and in some embodiments, more recent transactions are weighted higher to intentionally bias the system to account for short term or near term behavioral changes.

Furthermore, considering the rules of the rating model, a combination of rule matching and machine learning methods can be used. For example, using deep learning algorithms, a suitable learning model can be built using a massive dataset of user credit data for credit level prediction. The advantages of this method include: regularly retraining the credit model using recent datasets to effectively identify new risks; and for individual users, real-time inference and adjustment of rating results as credit data accumulates.

In operation, the approach can be used for different practical verification scenarios, where different aspects of the user’s verification response modifies how the interaction with a verifier terminal operates. For example, depending on the user’s credit score, different interactions and different user interface models can be invoked or different interface paths can be modified to allow for enhanced credit options, or conversely, for reduced rental options or the requiring of a deposit.

In these examples, the user has generated a set of verifiable credential data objects that are stored on a secure wallet or a secure memory region of their device. These verifiable credential data objects can be generated from time to time and issued from various institutions. In this example, the user also has one or more credit score derivative verifiable credential data objects that have been generated and signed by a signing authority indicating an overall score level associated with the user.

A first example is a “buy now, pay later/credit payments”, where a user, upon attempting to make a payment or attempting to purchase an object or a service, encounters an optional verification request at the terminal device that acts as a verifier device. The terminal device can, as part of the purchase transaction data messages, automatically send a verification request message to the user’s device, which can, in generating the response messages, in turn generate a response message data object that includes one or more verifiable presentation data objects as a payload. The verifiable presentation data objects are generated using zero knowledge proofs to indicate that the user’s credit rating, for example, is greater than a particular threshold. In this example, the terminal device sends a plurality of different requests together, each for different credit thresholds (e.g., >500, >600, >700, >750).

The user’s device generates a verifiable presentation data object in response to each query, and the devices together generate the zero knowledge proof circuit and corresponding secret numbers such that the user’s device generates a zero knowledge proof attestation for each of the thresholds, where it has been met. In some embodiments, the response attestation also includes verifiable digests based on the signed data objects such that the zero knowledge proof attestation can be back verified against the underlying certificate authorities that were used to generate the verifiable credential data objects.

The terminal device verifies that the user’s credit score is greater than a particular threshold, and then can automatically invoke a forked set of user interface interactions through the user interface controller where the user is now provided with the option for a combined loan for part of the purchase. Accordingly, in this example, the verifiable presentation data objects can thus be used in lieu of a specific credit ratings for assessing whether users are eligible for buy now, pay later options, as well as determine the credit limit, interest rates, and terms in credit payment scenarios. Depending on the user’s credit rating threshold, different credit limit, interest rates, and terms in credit payment scenarios can be provided.

Because zero knowledge proof attestations are used as proxies for each of the thresholds, the user’s private information, only to the extent needed to obtain the proof is provided, and other extraneous information is not leaked, such as the user’s actual credit score number. As less information is leaked, it becomes more difficult for a malicious user to impersonate the user, for example.

In another example, the system can be used for leasing services for properties, cars, etc., among others, and similarly, credit ratings are used to assess the user's probability of fulfillment, which can impact deposits and lease terms. The credit ratings can also influence whether users are eligible for loan repayment extensions, along with the associated interest rates and terms.

Based on verifications, a user may be eligible for certain expedited services through verification through the terminal interface. For example, during the verification process, based on identity proof and credit ratings, support can be provided to expedite or waive the submission of proof materials for process-related businesses, such as visa applications. Similarly, for insurance, Identity proof and credit ratings can lead to partial waiver of material requirements during the insurance application process. For insurance policies affected by credit records, credit ratings can also be configured to directly affect insurance premiums and coverage. In a microloans example, credit ratings can directly determine the loan amount and term for users.

The technology of this invention utilizes the standardized data provided by the CBDC platform, which not only improves the efficiency of financial services, but also enhances the collaborative ability between different financial service systems. Since all financial service institutions can operate on the same platform, seamless docking and data sharing between systems can be achieved, greatly improving the collaborative efficiency of financial services. At the same time, the credit rating and management of users is also more convenient and direct, further enhancing the overall efficiency of financial services and user experience.

It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures, and components have not been described in detail so as not to obscure the embodiments described herein. Furthermore, this description is not to be considered as limiting the scope of the embodiments described herein in any way, but rather as merely describing implementation of the various example embodiments described herein.

A technical approach is described herein that is adapted for overcoming some of the challenges associated with technical approaches at modelling credit ratings based on user behaviour data.

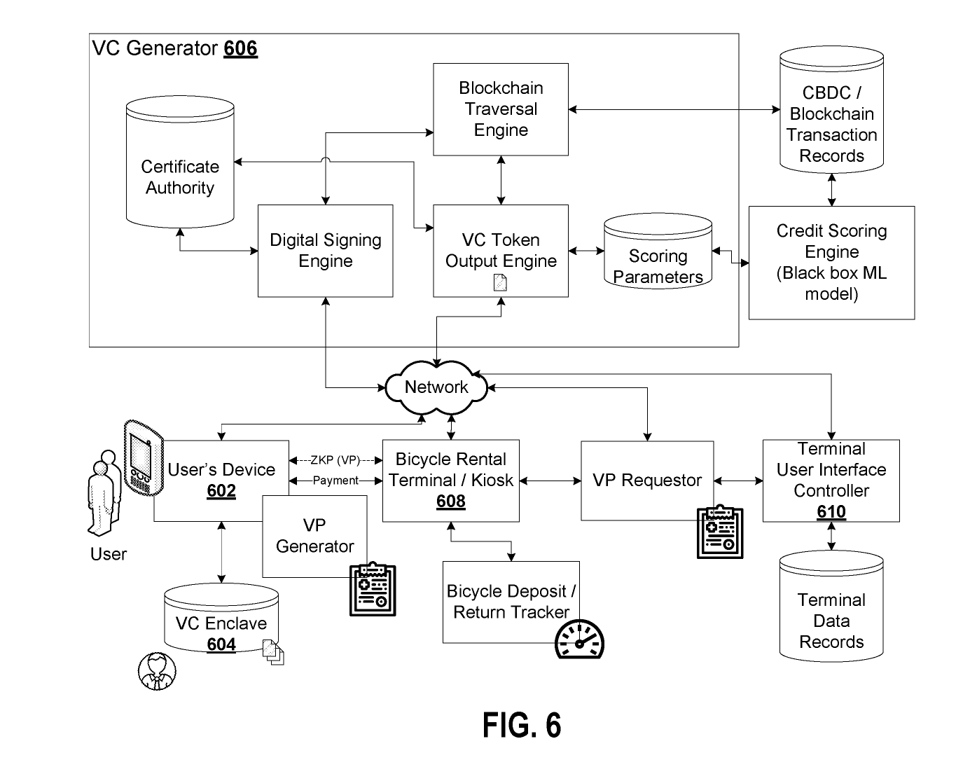

FIG. 6 shows a practical example where a user is attempting to rent a bicycle at a bicycle rental terminal, according to some embodiments.

The user has a user’s mobile device 602, the user’s smartphone, having an online banking mobile application that has established a secure data storage in a secure enclave 604 for the storage of verifiable credential data objects. The secure enclave is the user’s digital wallet, and it can be used to store data payloads that are verifiable credential data objects.

The online banking mobile application can be configured to transmit verifiable presentation payloads that can also be provided as part of a payment transaction, and the online banking mobile application may transmit the payload through various communication protocols, such as near field communications.

The user’s online banking application has enrolled a decentralized identifier into the verifiable credential data object generator 606, which is a computational process that can be interfaced through an application programming interface. The user is a student at the local high school, and requests a digital credential through the verifiable credential data object generator 606, and the student’s school data process (e.g., through the student portal) uses its signing engine to cryptographically generate a verifiable credential data object as a payload data file for the student to store on the user’s mobile device in the secure enclave 604. The payload data file may include, among others, specific information about the student’s enrollment, such as course load, which semester the student is in, the student’s unique identifier number, whether the student is a boarding or a regular student, among others.

The user also can use the verifiable credential data object generator 606 to generate one or more verifiable credential data objects pertaining to the student’s bank account history through Web 2.0 banking with the user’s financial institution, and can request, through a data message on an online banking interface triggered by the user requesting through a user interface form, that a verifiable credential data object be generated indicating that the user, as of the timestamp of the request, had an account balance of 10,000 RMB in the user’s savings account.

The user also has a digital wallet associated with the online banking application where the user tracks CBDC or other digital currencies or digital ownership, such as non-fungible tokens, among others. The digital wallet is represented by a public address, and the private key is managed by the online banking application. The user has had a history of CBDC transactions, and in this non-limiting example, the CBDC is represented by ERC-20 tokens on the Ethereum network, and it is possible to track the transaction flow as the user pays bills, sends money to friends, buys groceries, among others, using the digital wallet. The digital wallet thus acts as a repository of transaction flow that can be publicly accessed using a block explorer if the digital wallet address is known. However, traversing and generating the block explorer is computationally complicated and can be slow.

The user’s online banking application is configured to periodically generate expiring derivative tokens using the verifiable credential data object generator 606, which are derived based on one or more metrics relating to the user’s transaction flow and wallet holdings by the verifiable credential data object generator 606. These expiring derivative tokens are special tokens that generate a specific numerical value or score as a proxy value of the creditworthiness of the user. The user’s online banking application periodically generates these tokens and stores them on the device on a schedule, refreshing the token generation one week before the monthly expiry, and in some embodiments, this can be done automatically.

In this example, the credit rating model and backend mechanism is a dynamic machine learning based proprietary model where the credit rating methodology is designed to be a black box to deter malicious third parties. Accordingly, as a further non-limiting example, the verifiable credential data object generator 606 can be a smart contract that can store an encrypted machine learning model that is iteratively updated based on periodic traversal of flagged credit default transaction records, the encrypted machine learning model including parameters that modify the weightings of specific categories of transaction patterns in their contribution to a credit score. The initial weightings can be based, for example, on a baseline initial condition, such as 30% payment frequency, 30% holdings amount, and 40% loans to assets ratio, and as time goes on, these weighting values may be configured to float based on optimization on actual transaction and default behavior.

For example, the encrypted machine learning model may periodically traverse the blockchain to identify the latest set of defaults, and update weights of the neural network to optimize a loss function. The model weights itself may be encrypted such that only the verifiable credential data object generator 606 is able to decipher the values for usage of the model as a true black box. This can be practically implemented by having the smart contract implementing the verifiable credential data object generator 606 generate and store a keypair whose public key is used to encrypt the weights, but the private key is not made available at all and accessible by the verifiable credential data object generator 606 only to process incoming wallet addresses to generate credit scores.

Accordingly, the user generates these tokens and has them stored for usage by saving them into the secure enclave 604, and has a plurality of verifiable credential tokens saved. This can be done at an earlier time as the generation may require time to process (and thus conducting the operations once a month may reduce the overall computational burden and overall gas fees expended in generation).

In operation, the user approaches a bicycle rental terminal / kiosk 608 to rent a bicycle. The kiosk is designed to request a verifiable presentation token as part of the login data message flow, and the kiosk includes a terminal interface that is controlled by a backend terminal user interface controller that controls what user interface pages and options are shown to the user. The verifiable presentation token data object is requested so that the bicycle rental terminal / kiosk 608 can determine automatically whether to request a security deposit from the user (if the bicycle is not returned), and if so, how much.

The user’s device 602 receives the verifiable presentation token request, and the user’s device 602 and the bicycle rental terminal / kiosk 608 will trade zero knowledge protocol messages to have a trusted setup for a one-time communication channel. For example, the zero knowledge protocol can be established using zk-SNARKs protocol, among others, and used to establish that a logical condition, such as credit score > 500 = TRUE. The user’s device 602 processes the verifiable presentation token request and uses the verifiable credential tokens stored in the secure enclave, either individually or in combination, to generate the proof response attestation in the form of a responding verifiable presentation token. The bicycle rental terminal / kiosk 608 can be configured to request a number of different verifiable presentation tokens simultaneously. For example, there may be a discount program for students.

The user’s device 602 encapsulates a response message, indicating through zero knowledge proofs that the user is a student (without revealing the student’s identification number), and that the user’s credit score is greater than 600. While the bicycle rental terminal / kiosk 608 had also sent a request for a proof that the user’s credit score is greater than 700, the user does not have a sufficient score so this request is ignored. The submissions are also sent alongside digital signature proofs from the underlying sources of the verifiable credentials, such that the bicycle rental terminal / kiosk 608 is able to independently verify that the signature is from the user’s school, for example, or a credit score generation source.

The bicycle rental terminal / kiosk 608 then modifies the user interface flow based on the received response. This can be conducted through establishing branching / forking user interface behavior that is conditioned on the verifiable presentation token response. In this example, the user is eligible for a student discount, so the total cost is modified for the user. Because the user has a medium strength credit score, the terminal user interface controller 610 is also configured to request a smaller partial deposit instead of a full deposit for the bicycle. If the user had a higher credit score, the user may not have had to provide a deposit at all. The deposit handling user interface flows are invoked as part of the payment process flow by the terminal user interface controller 610.

The user then provides funds for payment of the bicycle rental. The bicycle is provided to the user by automatic unlocking from the bicycle rental terminal / kiosk 608, and the bicycle deposit / return tracker engine 612 tracks the user’s return timing and whether the user returned at all. In an example scenario, the user loses the bicycle and forfeits the partial deposit. However, the bicycle rental company has lost money. The bicycle rental company, through an automatic provisioning of the bicycle rental terminal / kiosk 608, automatically issues, onto the blockchain, a blockchain record of delinquency by the user, associated with the user’s public wallet address.

In a further embodiment, the verifiable credential data object generator 606, in generating future credit scores, may reduce similar demographic users as represented empirically by similar patterns of transaction records on the blockchain transaction records, through iteratively updating the machine learning model stored on the verifiable credential data object generator 606, reducing the propensity that a similar user to the student would be allowed to provide only a partial deposit.

In some embodiments, the negative record could also impact the ability of the user to refresh the credit score after expiry, either removing the ability entirely or significantly impacting the score for the future (e.g., the model penalizes them with a -400 score for 90 days, for example). Where the bicycle is found and returned late, for example, the bicycle rental terminal / kiosk 608 can be configured to automatically update the negative transaction record so that it is no longer impacting the user’s credit score, and because the system can be a “self serve” mechanism, the user can proactively request a new credit score data object for saving on the user’s mobile device. A benefit of the approach proposed herein is that the user can self-serve a credit score on an on-demand basis through the user’s device invoking the verifiable credential data object generator 606 without having to engage any credit scoring agency, among others, once the records were updated by the bicycle rental terminal / kiosk 608.

The protocol utilized to generate the verifiable presentation data object can be issuer agnostic, for example, and in some embodiments, the verifiable presentation data object that is acceptable for a particular transaction may include a level of flexibility (e.g., it doesn’t matter which financial institution so long as it is one of the major financial institutions), or differing combinations of digital assets or credit scores can be used as triggering conditions. For example, a newcomer to a country may have significant assets but not a well established transaction history. Accordingly, having a flexible approach would provide a useful mechanism for more accurately estimating credit risk automatically.

The term “connected” or "coupled to" may include both direct coupling (in which two elements that are coupled to each other contact each other) and indirect coupling (in which at least one additional element is located between the two elements).

Although the embodiments have been described in detail, it should be understood that various changes, substitutions and alterations can be made herein without departing from the scope. Moreover, the scope of the present application is not intended to be limited to the particular embodiments of the process, machine, manufacture, composition of matter, means, methods and steps described in the specification.

As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

As can be understood, the examples described above and illustrated are intended to be exemplary only.

What is claimed is:

1. A computer implemented method for interfacing with a blockchain node to traverse a distributed ledger data structure for generating a signed verifiable credential token data object usable for credit score estimation, the method comprising:
receiving, at the blockchain node, a request data message from a user to interface with a verifiable credential generation computational process configured to generate a de-centralized, self-managed identity certificate for a public key wallet address corresponding to the user, the verifiable credential generation computational process coupled with a signing authority private key stored thereon that is not accessible by any external processes used for signing the de-centralized, self-managed identity certificate;
traversing, by the verifiable credential generation computational process executing a block explorer process, the distributed ledger data structure to identify a quantity of data objects stored on the distributed ledger data structure corresponding to the public key wallet address and a plurality of confirmed transactions corresponding to the public key wallet address;
upon a determination that the quantity of the data objects stored on the distributed ledger data structure corresponding to the public key wallet address is greater than a pre-defined threshold and that there is a continuous pattern in the plurality of confirmed transactions corresponding to the public key wallet address greater than a pre-determined duration of time, generate, by the verifiable credential generation computational process data object, a verifiable credential token data object having at least an expiry time field digitally signed using the signing authority private key; and
outputting the signed verifiable credential token data object for storage, the signed verifiable credential token data object being configured for downstream electronic transmission as a component of a verifiable presentation data object to a verifier computing system that is configured to verify the verifiable credential token data object against both the expiry time field and a signing authority public key that corresponds to the signing authority private key, and upon a successful verification of the verifiable presentation data object, the expiry time field and the signing authority public key, the verifier computing system is configured to permit access to a controlled resource.

2. The method of claim 1, wherein the verifiable credential generation computational process is instantiated as an interactive smart contract data object persisted on a blockchain virtual machine providing a decentralized virtual environment for executing state change code consistently across distributed ledger data structures stored on corresponding blockchain nodes, the interactive smart contract data object automatically causing block traversal of transaction records associated with the public key wallet address generating the signed verifiable credential token data object that is stored locally on local memory of a portable computing device associated with the user, and the portable computing device includes one or more electronic transmitters that transmit the signed verifiable credential token data object to the verifier computing system during a physical transaction.

3. The method of claim 1, wherein the signed verifiable credential token data object further includes one or more data fields each representing one or more data values associated with the quantity of the data objects or the plurality of confirmed transactions, and wherein the verifier computing system is further configured to modify access to the controlled resource based upon the one or more data values.

4. The method of claim 3, wherein the modified access to the controlled resource based upon the one or more data values includes the verifier computing system automatically adjusting one or more values associated with parameters of a proposed electronic transaction, the parameters including at least one of a loan amount, an interest rate, eligibility for modified service options.

5. The method of claim 3, wherein the modified access to the controlled resource based upon the one or more data values includes the verifier computing system automatically injecting additional user interface paths into a user interface flow data structure controlling the rendering of user interface screens on a user interface coupled to the verifier computing system.

6. The method of claim 3, wherein the modified access to the controlled resource based upon the one or more data values includes the verifier computing system automatically removing additional user interface paths from a user interface flow data structure controlling the rendering of user interface screens on a user interface coupled to the verifier computing system.

7. The method of claim 1, wherein the verifier computing system is configured for offline verification through storing, on local data storage of the verifier computing system, the signing authority public key of the verifiable credential generation computational process.

8. The system of claim 2, wherein the verifier computing system is configured for online verification through retrieving, from the smart contract data object, the signing authority public key by querying a public address persisted by the smart contract data object.

9. The method of claim 8, wherein a transaction request data message from a user to interface the verifier computing system includes both the verifiable credential token data object and a pointer to the public address persisted by the smart contract data object.

10. The method of claim 3, wherein the verifiable credential generation computational process is configured to privately store or access a risk model for generating the one or more data values associated with the quantity of the data objects or the plurality of confirmed transactions.

11. A computer implemented system adapted for interfacing with a blockchain node to traverse a distributed ledger data structure for generating a signed verifiable credential token data object usable for credit score estimation, the system comprising:
a computer processor operating in conjunction with computer memory and non-transitory computer data storage, the computer processor configured to:
receive, at the blockchain node, a request data message from a user to interface with a verifiable credential generation computational process configured to generate a de-centralized, self-managed identity certificate for a public key wallet address corresponding to the user, the verifiable credential generation computational process coupled with a signing authority private key stored thereon that is not accessible by any external processes used for signing the de-centralized, self-managed identity certificate;
traverse, by the verifiable credential generation computational process executing a block explorer process, the distributed ledger data structure to identify a quantity of data objects stored on the distributed ledger data structure corresponding to the public key wallet address and a plurality of confirmed transactions corresponding to the public key wallet address;
upon a determination that the quantity of the data objects stored on the distributed ledger data structure corresponding to the public key wallet address is greater than a pre-defined threshold and that there is a continuous pattern in the plurality of confirmed transactions corresponding to the public key wallet address greater than a pre-determined duration of time, generate, by the verifiable credential generation computational process data object, a verifiable credential token data object having at least an expiry time field digitally signed using the signing authority private key; and
output the signed verifiable credential token data object for storage, the signed verifiable credential token data object being configured for downstream electronic transmission as a component of a verifiable presentation data object to a verifier computing system that is configured to verify the verifiable credential token data object against both the expiry time field and a signing authority public key that corresponds to the signing authority private key, and upon a successful verification of the verifiable presentation data object, the expiry time field and the signing authority public key, the verifier computing system is configured to permit access to a controlled resource.

12. The system of claim 11, wherein the verifiable credential generation computational process is instantiated as an interactive smart contract data object persisted on a blockchain virtual machine providing a decentralized virtual environment for executing state change code consistently across distributed ledger data structures stored on corresponding blockchain nodes, the interactive smart contract data object automatically causing block traversal of transaction records associated with the public key wallet address generating the signed verifiable credential token data object that is stored locally on local memory of a portable computing device associated with the user, and the portable computing device includes one or more electronic transmitters that transmit the signed verifiable credential token data object to the verifier computing system during a physical transaction.

13. The system of claim 11, wherein the signed verifiable credential token data object further includes one or more data fields each representing one or more data values associated with the quantity of the data objects or the plurality of confirmed transactions, and wherein the verifier computing system is further configured to modify access to the controlled resource based upon the one or more data values.

14. The system of claim 13, wherein the modified access to the controlled resource based upon the one or more data values includes the verifier computing system automatically adjusting one or more values associated with parameters of a proposed electronic transaction, the parameters including at least one of a loan amount, an interest rate, eligibility for modified service options.

15. The system of claim 13, wherein the modified access to the controlled resource based upon the one or more data values includes the verifier computing system automatically injecting additional user interface paths into a user interface flow data structure controlling the rendering of user interface screens on a user interface coupled to the verifier computing system.

16. The system of claim 13, wherein the modified access to the controlled resource based upon the one or more data values includes the verifier computing system automatically removing additional user interface paths from a user interface flow data structure controlling the rendering of user interface screens on a user interface coupled to the verifier computing system.

17. The system of claim 11, wherein the verifier computing system is configured for offline verification through storing, on local data storage of the verifier computing system, the signing authority public key of the verifiable credential generation computational process.

18. The system of claim 12, wherein the verifier computing system is configured for online verification through retrieving, from the smart contract data object, the signing authority public key by querying a public address persisted by the smart contract data object.

19. The system of claim 18, wherein a transaction request data message from a user to interface the verifier computing system includes both the verifiable credential token data object and a pointer to the public address persisted by the smart contract data object.

20. A non-transitory computer readable medium, storing computer interpretable instructions, which when executed by a computer processor, cause the computer processor to execute a computer implemented method for interfacing with a blockchain node to traverse a distributed ledger data structure for generating a signed verifiable credential token data object usable for credit score estimation, the method comprising:
receiving, at the blockchain node, a request data message from a user to interface with a verifiable credential generation computational process configured to generate a de-centralized, self-managed identity certificate for a public key wallet address corresponding to the user, the verifiable credential generation computational process coupled with a signing authority private key stored thereon that is not accessible by any external processes used for signing the de-centralized, self-managed identity certificate;
traversing, by the verifiable credential generation computational process executing a block explorer process, the distributed ledger data structure to identify a quantity of data objects stored on the distributed ledger data structure corresponding to the public key wallet address and a plurality of confirmed transactions corresponding to the public key wallet address;
upon a determination that the quantity of the data objects stored on the distributed ledger data structure corresponding to the public key wallet address is greater than a pre-defined threshold and that there is a continuous pattern in the plurality of confirmed transactions corresponding to the public key wallet address greater than a pre-determined duration of time, generate, by the verifiable credential generation computational process data object, a verifiable credential token data object having at least an expiry time field digitally signed using the signing authority private key; and
outputting the signed verifiable credential token data object for storage, the signed verifiable credential token data object being configured for downstream electronic transmission as a component of a verifiable presentation data object to a verifier computing system that is configured to verify the verifiable credential token data object against both the expiry time field and a signing authority public key that corresponds to the signing authority private key, and upon a successful verification of the verifiable presentation data object, the expiry time field and the signing authority public key, the verifier computing system is configured to permit access to a controlled resource.
